(19) United States
(12) Patent Application Publication
(10) Pub. No.: US 2013/0177882 A1
(43) Pub. Date: Jul. 11, 2013

(54) TRAINING SYSTEMS FOR ADAPTIVE AND MALLEABLE EXPERTISE

(71) Applicants: Anand Tharanathan, Plymouth, MN (US); Hari Thiruvengada, Plymouth, MN (US); Paul Derby, Lubbock, TX (US)

(72) Inventors: Anand Tharanathan, Plymouth, MN (US); Hari Thiruvengada, Plymouth, MN (US); Paul Derby, Lubbock, TX (US)

(73) Assignee: Honeywell International Inc., Morristown, NJ (US)

(21) Appl. No.: 13/345,344

(22) Filed: Jan. 6, 2012

(51) Int. Cl. G09B 19/00

(52) U.S. Cl. 434/219

(57) ABSTRACT

A system identifies cognitive skills applicable to a particular job domain. The system stores cognitive skills from a plurality of job domains in a computer storage device. The cognitive skills are mapped to the plurality of job domains. The system creates a model of the stored cognitive skills. The model includes the plurality of job domains, and each job domain is associated with one or more scenarios, and each scenario is associated with a subset of the stored cognitive skills. This results in a matrix of job domains, scenarios, and cognitive skills. The system also generates a training sequence using the matrix. The training sequence includes multiple scenarios and relevant cognitive skills associated with each of the multiple scenarios across multiple job domains, thereby creating a system to generate an adaptable level of cognitive expertise.

### TECHNICAL FIELD

The present disclosure relates to a training system for adaptive and malleable expertise.

### BACKGROUND

A 2011 report from the National Training and Simulation Association (NTSA) indicates that there is a need to develop economical, effective, and smart training systems to improve rapid decision making skills. However, a problem for most training systems is the inability to prepare trainees to function effectively in novel situations. A reason for the problems in performance in novel situations is due to the type of skill-training that is offered through most of the currently available training programs. More specifically, trainees are trained in a specific domain with several different scenarios of varying complexity. With such an approach, it is expected that they can develop and hone the specific skills required for their task. As a result, trainees come out of such programs as routine experts. Routine experts have an excellent capability to execute a set of trained skills in situations to which they have been previously exposed (e.g., during training sessions). However, if they are exposed to novel situations in the real-world, that have different surface level cues, their cognitive performance drops down to the level of novices. This results in a significant reduction in performance.

### BRIEF DESCRIPTION OF THE DRAWINGS

FIG. 1 illustrates a relationship between training scenarios and real world situations.

FIG. 2 illustrates a cognitive architecture for novices.

FIG. 3 illustrates a cognitive architecture for routine experts.

FIG. 4 illustrates a cognitive architecture for adaptive experts.

FIG. 5 illustrates an example of game-based training for adaptive and malleable expertise.

FIG. 6 is a flowchart illustrating an example embodiment of a process to generate a training system for adaptable and malleable expertise.

FIG. 7 illustrates an example of a computer processor system upon which an embodiment of the present disclosure can execute.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

An embodiment prepares trainees to be adaptive experts. Adaptive experts have the same organizational structure of knowledge packets in their cognitive architecture as do routine experts. A difference from the organizational structure of routine experts however is that the knowledge packets for an adaptive expert are arranged in a more malleable manner, which allows for quicker and improved argumentative reasoning, in-depth evaluation of information, and quick retrieval of knowledge packets. In short, the cognitive efficiency of adaptive experts is high, and is better than routine experts in novel situations. In an embodiment, a game is used to train for this type of expertise. However, the use of a game is just one method.

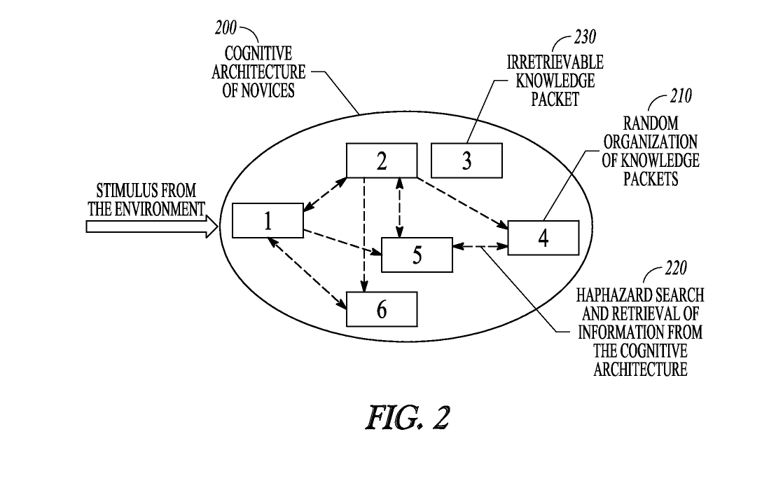

FIGS. 2, 3, and 4 illustrate the differences between novices, routine experts, and adaptive experts. As illustrated in FIG. 2 at 200, in a cognitive architecture of novices, knowledge packets and skills within the cognitive architecture are arranged in a random manner at 210. At 220, information is searched and retrieved in a haphazard manner from the cognitive architecture. Unfortunately, this is a slow and inefficient process, and as shown at 230, some knowledge packet and skills cannot be retrieved.

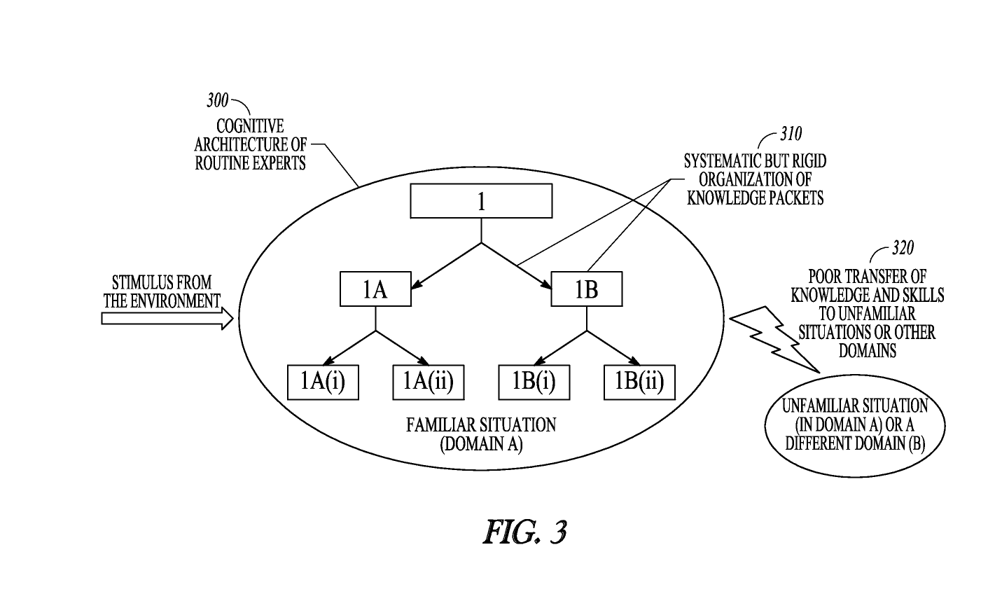

A cognitive architecture of routine experts 300 is illustrated in FIG. 3. The cognitive architecture 300 is arranged in an organized and systematic, but rigid, manner as illustrated at 310. The organized and systematic aspects of the cognitive architecture 300 result in quick and efficient searching and retrieval, but only in familiar situations. As shown at 320, there is a poor transfer of knowledge and skills to unfamiliar situations or other domains.

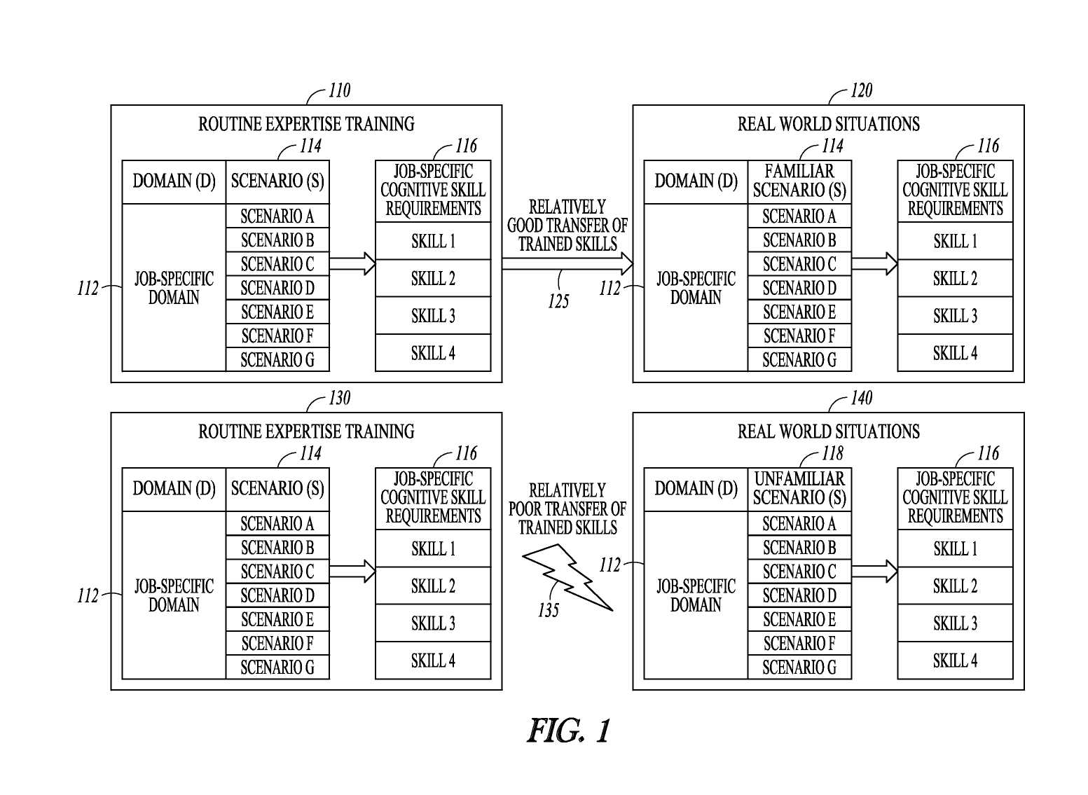

Routine experts are able to execute a set of trained skills in the same domain. The domain may include a set of scenarios or situations that vary in complexity. FIGS. 1A and 1B illustrate the effects of routine expert training in two real world scenarios. FIG. 1A illustrates in a matrix 110 a job-specific domain 112, and several scenarios 114 that are applicable to that job-specific domain 112. Cognitive skills 116 are known as skills that are helpful for a person to have for this job specific domain. Then, in a real world situation 120 that deals with the same job-specific domain 112, the same scenarios 114, and the same cognitive skills 116, there is a relatively good transfer of trained skills at 125. FIG. 1B shows at 130 however when a person is trained in a job-specific domain 112, with scenarios 114 and associated skills 116, and then is presented in the real world 140 with familiar job-specific domain 112 and cognitive skills 116, but with a different set of novel scenarios 118, there is a relatively poor transfer of the trained skills at 135.

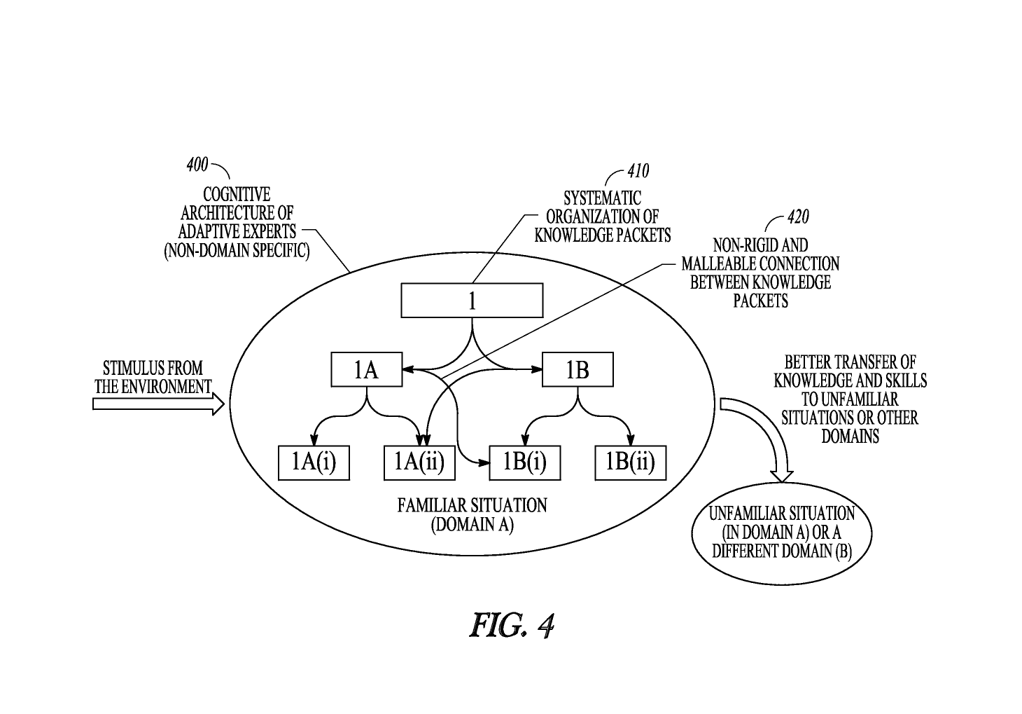

Adaptive experts, on the other hand, are able to execute a set of trained skills in different domains. The domains may include a set of scenarios or situations that vary in both complexity and familiarity. FIG. 4 illustrates a cognitive architecture 400 of adaptive experts. The cognitive architecture 400 is domain-specific, and the knowledge packets and skills, like with the routine cognitive architecture 300, are arranged in an organized manner at 410. A difference between the cognitive architecture of adaptive experts 400 and the cognitive architecture of routine experts 300 is that there is a lack of rigidity in the adaptive expert architecture 400. As illustrated at 420, there is a malleable and adaptable connection between knowledge packets, as contrasted to the rigid organization of packets at 310. This adaptable and malleable connection is developed by exposing a trainee to scenarios and skills that normally do not fall within his or her specific job domain, or the specific job domain for which that person is being trained. As a result, there is quick and improved argumentative reasoning and in-depth evaluation of information, the overall process is quick and efficient, and there is a better transfer of knowledge and skills to unfamiliar situations or other domains.

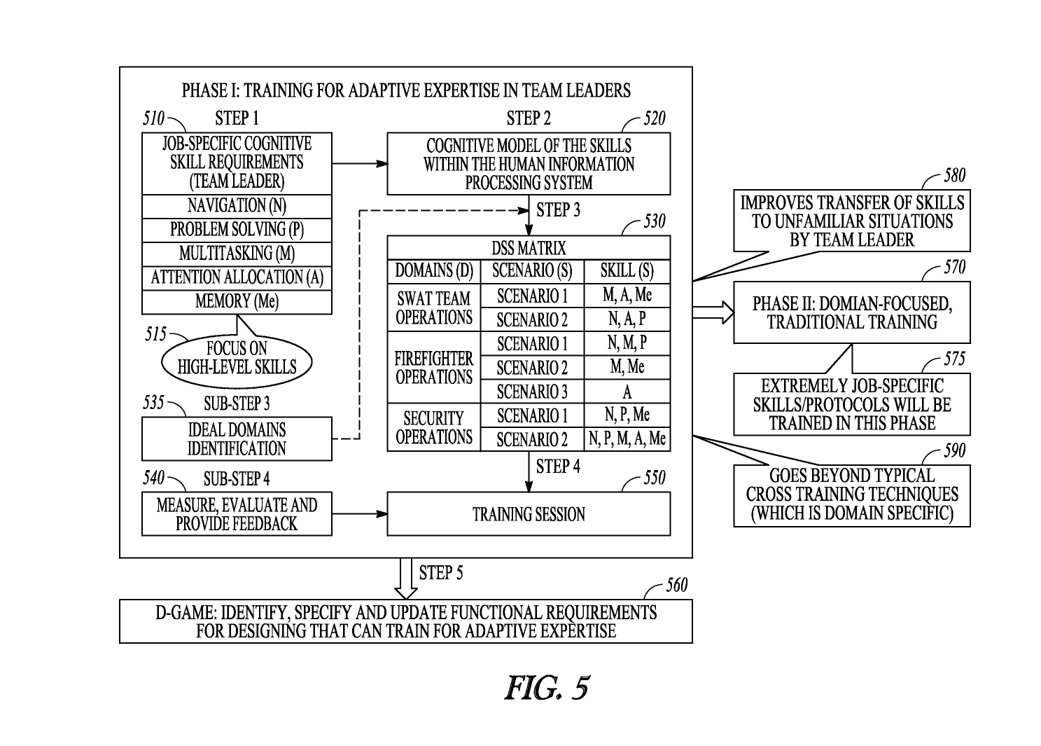

FIG. 5 illustrates a model for a game-based training for adaptive and malleable expertise. The example of FIG. 5 relates to the training of a team leader. Phase I of the training includes a first step of identifying job-specific cognitive skill requirements at 510. In an embodiment, the first step focuses on high level skills 515 for the job-specific skill requirements, and in the example of FIG. 5, these skills for a team leader are navigation, problem solving, multitasking, attention allocation, and memory. A second step of generating a cognitive model of the skills within a human information processing system is illustrated at 520, and a third step of generating a domain, scenario, and skills (DSS) matrix is illustrated at 530. In an embodiment, before the matrix 530 is generated, the ideal domains are identified at 535. The matrix 530 includes a plurality of job-specific domains, and for each of those job-specific domains, scenarios that are associated with those domains, and for each of those scenarios, a set of skills. An example of a scenario for a team leader is one in which he or she has to analyze information received from a remote location, for example from a command and control room, use multi-tasking skills to analyze the incoming information and communicate it effectively to the team members. This has to be done simultaneously with the planning and coordination of tasks. Further, based on the location that needs to be reached or targeted, the team leader has to use problem solving and navigation skills to physically move the whole team to the right location. Finally, while executing follow on orders, taking actions, and responding to upcoming situations, the team leader, depending on the context, has to effectively allocate resources without forgetting the details of the mission. A fourth step at 550 implements a training session using the matrix 530. That is, a trainee is exposed to the scenarios and cognitive skills of other job-specific domains. At 540, the training session 550 is measured and evaluated, and feedback is provided. In a fifth step 560, functional requirements are identified, specified, and updated for designing games that can train for adaptive expertise. Specifically, based on the output of the executed training framework, the most effective domains and scenarios that can train the relevant persona for adaptive expertise are identified and validated. Then, functional requirements are developed to design games that utilize the most demanding domains and scenarios for adaptive expertise training. As noted at 580, the training for adaptive leaders improves the transfer of skills to unfamiliar situations. Moreover, as indicated at 590, the game-based training for adaptive and malleable expertise goes beyond typical cross training techniques, which are domain specific. Thereafter, in a second phase at 570, a domain-focused traditional training regimen can be implemented.

Further details of the phases and steps of FIG. 5 are as follows. Phase 1 is designed to train for adaptive expertise and to overcome the disadvantages associated with training “exclusively” for domain-specific routine expertise. As noted above, within this phase, there are four steps, and an associated fifth step. In a first step (510), through a detailed cognitive task analysis and functional decomposition of the decision making process, job-specific cognitive skills (e.g., navigation, divided attention, memory, etc.) are identified. In an embodiment, the focus is put on the higher level cognitive skills rather than the micro-level skills that are extremely specific to the domain. In general, higher level cognitive skills relate to a macro level of cognitive skills that that comprise a set of micro level skills. For example, multitasking is a macro level cognitive skill that requires and comprises micro level skills like focused attention and working memory. As noted above, examples of higher level cognitive skills for a team leader may include navigation, problem solving, multitasking, attention allocation, and memory, and examples of lower level cognitive skills for a team leader may include a highly efficient working memory, an efficient allocation of attention, and competent meta-cognitive capabilities. The micro-level cognitive skills can be identified using progressive deepening techniques of knowledge engineering. Thereafter, the cognitive skills can be validated with subject matter experts. A cognitive model can then be created that captures and represents the levels of cognitive information processing and how the cognitive components are organized within the system.

In a second step (520), once the cognitive skills are identified, the skills are modeled within compartments of a human information processing system. More specifically, the human information processing system can be divided or compartmentalized into four stages. Namely, the information acquisition stage, the information analysis stage, the decision making and action selection stage, and the action execution stage. Each of the cognitive skills identified as critical are modeled within these four stages. Agent-based models are developed and designed to function within a game as a team member, enemy, or trainer. In a third step (530), a first task identifies the most ideal or effective domains that can be used to train the higher-level cognitive skills. For example, a platoon leader in a military operation would need higher level cognitive skills such as navigation, attention allocation, problem solving, and multitasking. Other domains that demand these higher-level skills could be SWAT team operations, firefighting operations, and intelligence operations. While these other domains may share some of the same high level cognitive skills, these other domains may also demand different skills at different levels. It is helpful to create multiple training scenarios within each of these domains, and each scenario should be mapped to specific higher-level cognitive skills. At the end of the third step (530), there should be a complete Domain-Scenario-Skill (DSS) matrix that can be plugged in to the training system.

In a fourth step (550), a trainee goes through multiple scenarios across multiple domains that are identified by the system. The multiple scenarios across multiple domains demand multiple higher-level cognitive skills. At the end of the training session (560, 570), the trainees have a malleable and adaptable level of cognitive expertise. More specifically, a trainee would be able to quickly adapt to a novel situation and bring in experience from multiple domains to solve a problem at hand. In this fourth step, it is helpful to measure and evaluate performance in addition to providing detailed feedback that is centered on each higher-level cognitive skill that is being trained.

After these four steps are completed, one should be able to identify, specify, and continuously update and improve the functional requirements for designing games that can train for adaptive and malleable expertise. There are at least two aspects of this game-oriented process. First, the game approach asserts the importance of a focused, domain specific training. This occurs at 570 in a Phase 2 as illustrated in FIG. 5. The games should be used as Phase 1 and also for a proficiency improvement at different stages after Phase 2. Second, this game-oriented approach is different from cross-training. In cross-training, trainees are provided skills training in the same domain, but for different personas, who are part of a team or group. In contrast, in the presently disclosed game-oriented approach, different domains are used for training higher-level cognitive skills.

There are several advantages to using the cognitive architecture for adaptive experts. The architecture allows one to identify a specific persona for a particular job and the macro level skills and micro level skills that are relevant to the persona. The architecture further permits the creation of a cognitive model that captures and represents the levels of cognitive information processing and how the cognitive components are organized.

Additionally, the domains that demand the highly specific job skills are identified, the relative cognitive skills are organized within the stages of information processing, and demand weights are assigned for each cognitive skill within a domain. Scores can then be calculated, and the scores prioritized so that the most demanding domains can be selected to train the specific persona for adaptive expertise. Based on the skills model, the domains that highly demand the job-specific cognitive skills are identified.

More specifically, using cognitive walkthroughs, an extensive investigation can be conducted of domains (jobs) that require similar cognitive skills as that of the to-be-trained persona. For each of those identified domains (535), a scoring algorithm can be used that indicates a demand-weight (the level of demand) for each cognitive skill. Based on the final scores for each domain, the domains can be prioritized as most demanding to least demanding based on the relevant cognitive skills. The analysis can be validated using inter-rater reliability techniques and expert input (within and across domains). The scores are then prioritized so that the most demanding domains can be selected to train the specific persona for adaptive expertise. Then, based on the trainee's performance score for each cognitive skill, the curriculum dynamically retrieves appropriate lessons for training.

The architecture further allows, based on the skills model and the domain model, the development of scenarios of varying complexities for training within each domain. Additionally, based on a trainee's performance score for each cognitive skill, the architecture permits the dynamic retrieval of appropriate lessons for training. The architecture further permits the development of functional requirements to design games that utilize the most demanding domains and scenarios for adaptive expertise training that can be accessed quickly, anytime, and anywhere.

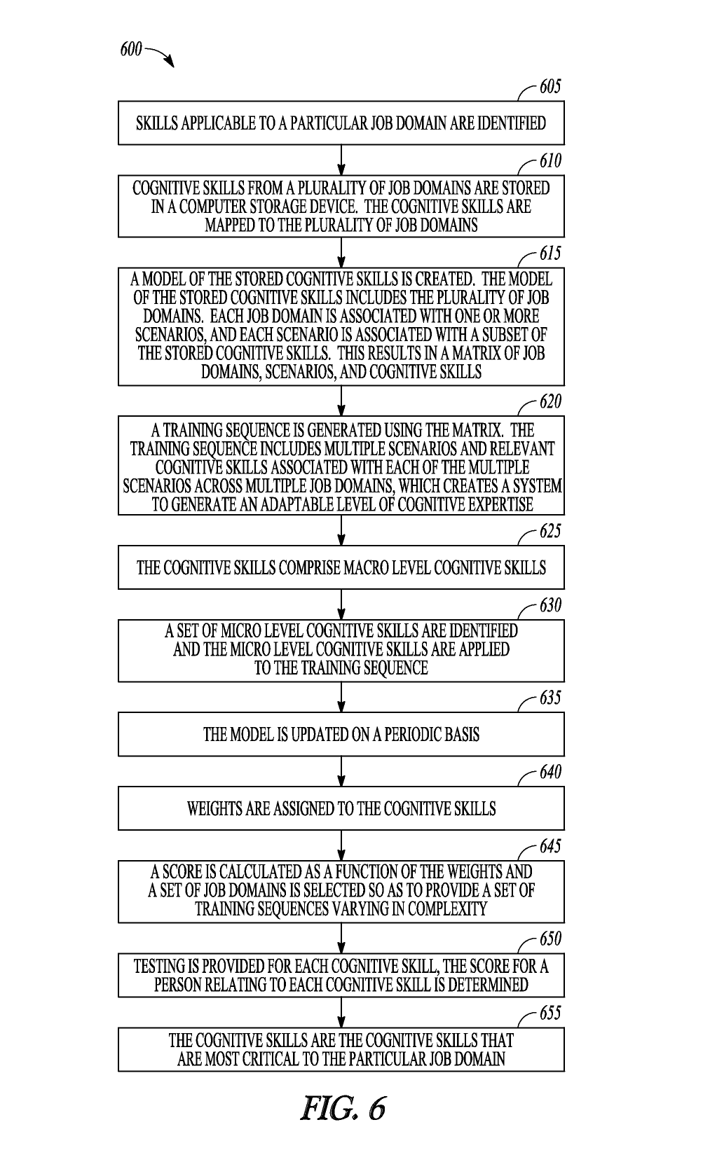

FIG. 6 is a flowchart of an example process 600 for generating a training system for adaptive and malleable expertise. FIG. 6 includes a number of process blocks 605-655. Though arranged serially in the example of FIG. 6, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 6, at 605, cognitive skills applicable to a particular job domain are identified. At 610, cognitive skills from a plurality of job domains are stored in a computer storage device. The cognitive skills are mapped to the plurality of job domains. At 615, a model of the stored cognitive skills is created. The model of the stored cognitive skills includes the plurality of job domains. Each job domain is associated with one or more scenarios, and each scenario is associated with a subset of the stored cognitive skills. This results in a matrix of job domains, scenarios, and cognitive skills. At 620, a training sequence is generated using the matrix. The training sequence includes multiple scenarios and relevant cognitive skills associated with each of the multiple scenarios across multiple job domains, which creates a system to generate an adaptable level of cognitive expertise.

At 625, the cognitive skills comprise macro level cognitive skills, and at 630, a set of micro level cognitive skills are identified and the micro level cognitive skills are applied to the training sequence. At 635, the model is updated on a periodic basis. At 640, weights are assigned to the cognitive skills. The weights relate to a difficulty and criticality associated with a particular job domain and one or more specific needs. At 645, a score is calculated as a function of the weights and a set of job domains is selected so as to provide a set of training sequences varying in complexity. The system is configured so that these training sequences eventually lead to enhanced performance, lower variance during training, enhance retention of learned material, and aid in the development of malleable cognitive skills. At 650, testing is provided for each cognitive skill, the score for a person relating to each cognitive skill is determined, and a particular training sequence as a function of the score is determined. At 655, the cognitive skills are the cognitive skills that are most critical to the particular job domain.

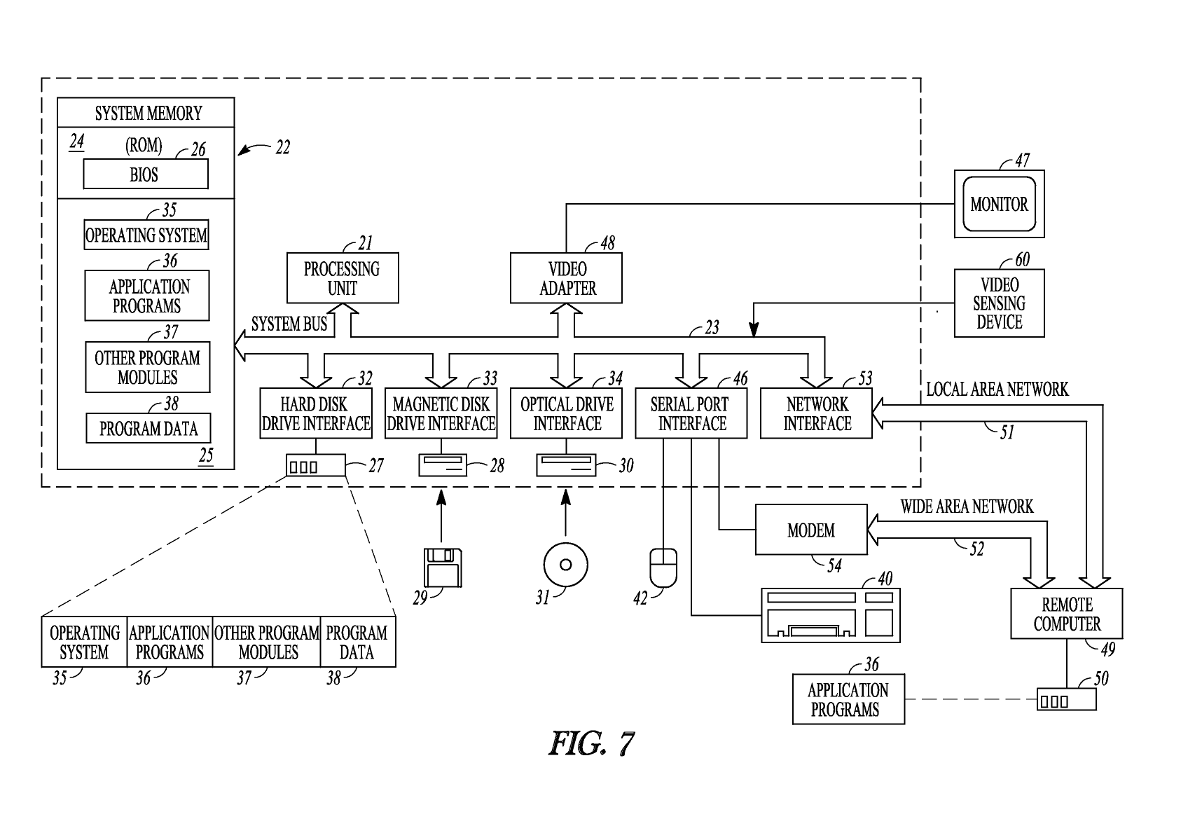

FIG. 7 is an overview diagram of a hardware and operating environment in conjunction with which embodiments of the invention may be practiced. The description of FIG. 7 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 7, a hardware and operating environment is provided that is applicable to any of the servers and/or remote clients shown in the other Figures.

As shown in FIG. 7, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 7 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### Example Embodiments

Several embodiments and sub-embodiments have been disclosed above, and it is envisioned that any embodiment can be combined with any other embodiment or sub-embodiment. Specific examples of such combinations are illustrated in the examples below.

Example No. 1 is a system including one or more of a computer processor and a computer storage device configured to identify cognitive skills applicable to a particular job domain, and store cognitive skills from a plurality of job domains. The cognitive skills are mapped to the plurality of job domains. The computer processor is also configured to create a model of the stored cognitive skills. The model includes the plurality of job domains, each job domain is associated with one or more scenarios, and each scenario is associated with a subset of the stored cognitive skills, thereby creating a matrix of job domains, scenarios, and cognitive skills. The computer processor is further configured to generate a training sequence using the matrix. The training sequence includes multiple scenarios and relevant cognitive skills associated with each of the multiple scenarios across multiple job domains, thereby creating a system to generate an adaptable level of cognitive expertise.

Example No. 2 includes the features of Example No. 1 and optionally includes a system wherein the cognitive skills include macro level cognitive skills.

Example No. 3 includes the features of Examples Nos. 1-2 and optionally includes a system wherein the computer processor is configured to identify a set of micro level cognitive skills and to apply the micro level cognitive skills to the training sequence.

Example No. 4 includes the features of Examples Nos. 1-3 and optionally includes a system wherein the computer processor is configured to update the model on a periodic basis.

Example No. 5 includes the features of Examples Nos. 1-4 and optionally includes a system wherein the computer processor is configured to assign weights to the cognitive skills, the weights relating to a difficulty and criticality associated with a particular job domain and one or more specific needs.

Example No. 6 includes the features of Examples Nos. 1-5 and optionally includes a system wherein the computer processor is configured to calculate a score as a function of the weights and to select a set of job domains so as to provide a set of training sequences varying in complexity.

Example No. 7 includes the features of Examples Nos. 1-6 and optionally includes a system wherein the computer processor is configured to provide testing for each cognitive skill, determine the score for a person relating to each cognitive skill, and determine a particular training sequence as a function of the score.

Example No. 8 includes the features of Examples Nos. 1-7 and optionally includes a system wherein the cognitive skills are the cognitive skills that are most critical to the particular job domain.

Example No. 9 is a process including identifying cognitive skills applicable to a particular job domain, and storing cognitive skills from a plurality of job domains in a computer storage device. The cognitive skills are mapped to the plurality of job domains. The process includes creating a model of the stored cognitive skills. The model includes the plurality of job domains, each job domain is associated with one or more scenarios, and each scenario is associated with a subset of the stored cognitive skills, thereby creating a matrix of job domains, scenarios, and cognitive skills. The process also includes generating a training sequence using the matrix. The training sequence includes multiple scenarios and relevant cognitive skills associated with each of the multiple scenarios across multiple job domains, thereby creating a system to generate an adaptable level of cognitive expertise.

Example No. 10 includes the features of Examples No. 9 and optionally includes a process wherein the cognitive skills comprise macro level cognitive skills.

Example No. 11 includes the features of Examples Nos. 9-10 and optionally includes a process comprising identifying a set of micro level cognitive skills and applying the micro level cognitive skills to the training sequence.

Example No. 12 includes the features of Examples Nos. 9-11 and optionally includes a process comprising updating the model on a periodic basis.

Example No. 13 includes the features of Examples Nos. 9-12 and optionally includes a process comprising assigning weights to the cognitive skills, the weights relating to a difficulty and criticality associated with a particular job domain and one or more specific needs.

Example No. 14 includes the features of Examples Nos. 9-13 and optionally includes a process comprising calculating a score as a function of the weights and selecting a set of job domains so as to provide a set of training sequences varying in complexity.

Example No. 15 includes the features of Examples Nos. 9-14 and optionally includes a process comprising providing testing for each cognitive skill, determining the score for a person relating to each cognitive skill, and determining a particular training sequence as a function of the score.

Example No. 16 includes the features of Examples Nos. 9-15 and optionally includes a process wherein the cognitive skills are the cognitive skills that are most critical to the particular job domain.

Example No. 17 is a computer readable storage device comprising instructions that when executed by a processor execute a process comprising identifying cognitive skills applicable to a particular job domain, and storing cognitive skills from a plurality of job domains in a computer storage medium. The cognitive skills are mapped to the plurality of job domains. There are instructions for creating a model of the stored cognitive skills. The model includes the plurality of job domains, each job domain is associated with one or more scenarios, and each scenario is associated with a subset of the stored cognitive skills, thereby creating a matrix of job domains, scenarios, and cognitive skills. There are instructions for generating a training sequence using the matrix. The training sequence includes multiple scenarios and relevant cognitive skills associated with each of the multiple scenarios across multiple job domains, thereby creating a system to generate an adaptable level of cognitive expertise.

Example No. 18 includes the features of Examples No. 17 and optionally includes a computer readable storage device wherein the cognitive skills comprise macro level cognitive skills; and comprising instructions for identifying a set of micro level cognitive skills and applying the micro level cognitive skills to the training sequence.

Example No. 19 includes the features of Examples Nos. 17-18 and optionally includes a computer readable storage device comprising instructions for assigning weights to the cognitive skills. The weights relate to a difficulty and criticality associated with a particular job domain and one or more specific needs. The computer readable storage device also includes instructions for calculating a score as a function of the weights and selecting a set of job domains so as to provide a set of training sequences varying in complexity.

Example No. 20 includes the features of Examples Nos. 17-19 and optionally includes a computer readable storage device comprising instructions for providing testing for each cognitive skill, determining the score for a person relating to each cognitive skill, and determining a particular training sequence as a function of the score.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
one or more of a computer processor and a computer storage device configured to:
identify cognitive skills applicable to a particular job domain;
store cognitive skills from a plurality of job domains, wherein the cognitive skills are mapped to the plurality of job domains;
create a model of the stored cognitive skills, the model comprising the plurality of job domains, each job domain associated with one or more scenarios, and each scenario associated with a subset of the stored cognitive skills, thereby creating a matrix of job domains, scenarios, and cognitive skills; and
generate a training sequence using the matrix, the training sequence comprising multiple scenarios and relevant cognitive skills associated with each of the multiple scenarios across multiple job domains, thereby creating a system to generate an adaptable level of cognitive expertise.

2. The system of claim 1, wherein the cognitive skills comprise macro level cognitive skills.

3. The system of claim 2, wherein the computer processor is configured to identify a set of micro level cognitive skills and to apply the micro level cognitive skills to the training sequence.

4. The system of claim 1, wherein the computer processor is configured to update the model on a periodic basis.

5. The system of claim 1, wherein the computer processor is configured to assign weights to the cognitive skills, the weights relating to a difficulty and criticality associated with a particular job domain and one or more specific needs.

6. The system of claim 5, wherein the computer processor is configured to calculate a score as a function of the weights and to select a set of job domains so as to provide a set of training sequences varying in complexity.

7. The system of claim 1, wherein the computer processor is configured to provide testing for each cognitive skill, determine the score for a person relating to each cognitive skill, and determine a particular training sequence as a function of the score.

8. The system of claim 1, wherein the cognitive skills are the cognitive skills that are most critical to the particular job domain.

9. A process comprising:
identifying cognitive skills applicable to a particular job domain;
storing cognitive skills from a plurality of job domains, wherein the cognitive skills are mapped to the plurality of job domains;
creating a model of the stored cognitive skills, the model comprising the plurality of job domains, each job domain associated with one or more scenarios, and each scenario associated with a subset of the stored cognitive skills, thereby creating a matrix of job domains, scenarios, and cognitive skills; and
generating a training sequence using the matrix, the training sequence comprising multiple scenarios and relevant cognitive skills associated with each of the multiple scenarios across multiple job domains, thereby creating a system to generate an adaptable level of cognitive expertise.

10. The process of claim 9, wherein the cognitive skills comprise macro level cognitive skills.

11. The process of claim 10, comprising identifying a set of micro level cognitive skills and applying the micro level cognitive skills to the training sequence.

12. The process of claim 9, comprising updating the model on a periodic basis.

13. The process of claim 9, comprising assigning weights to the cognitive skills, the weights relating to a difficulty and criticality associated with a particular job domain and one or more specific needs.

14. The process of claim 13, comprising calculating a score as a function of the weights and selecting a set of job domains so as to provide a set of training sequences varying in complexity.

15. The process of claim 9, comprising providing testing for each cognitive skill, determining the score for a person relating to each cognitive skill, and determining a particular training sequence as a function of the score.

16. The process of claim 9, wherein the cognitive skills are the cognitive skills that are most critical to the particular job domain.

17. A computer readable storage device comprising instructions that when executed by a processor execute a process comprising:
identifying cognitive skills applicable to a particular job domain;
storing cognitive skills from a plurality of job domains, wherein the cognitive skills are mapped to the plurality of job domains;
creating a model of the stored cognitive skills, the model comprising the plurality of job domains, each job domain associated with one or more scenarios, and each scenario associated with a subset of the stored cognitive skills, thereby creating a matrix of job domains, scenarios, and cognitive skills; and
generating a training sequence using the matrix, the training sequence comprising multiple scenarios and relevant cognitive skills associated with each of the multiple scenarios across multiple job domains, thereby creating a system to generate an adaptable level of cognitive expertise.

18. The computer readable storage device of claim 17, wherein the cognitive skills comprise macro level cognitive skills; and comprising instructions for identifying a set of micro level cognitive skills and applying the micro level cognitive skills to the training sequence.

19. The computer readable storage device of claim 17, comprising instructions for assigning weights to the cognitive skills, the weights relating to a difficulty and criticality associated with a particular job domain and one or more specific needs; and comprising instructions for calculating a score as a function of the weights and selecting a set of job domains so as to provide a set of training sequences varying in complexity.

20. The computer readable storage device of claim 17, comprising instructions for providing testing for each cognitive skill, determining the score for a person relating to each cognitive skill, and determining a particular training sequence as a function of the score.
